(19) United States
(12) Patent Application Publication
(10) Pub. No.: US 2007/0280283 A1
(43) Pub. Date: Dec. 6, 2007

(54) IGMP (Internet Group Management Protocol) connectivity verification

(75) Inventors: Piero Sorrini, Ottawa (CA); Gatot Susilo, Kanata (CA)

Correspondence Address: Arnold B. Silverman, Esq.;Eckert Seamans Cherin & Mellott, LLC, 44th Floor, 600 Grant Street, Pittsburgh, PA, 15219, US

(73) Assignee: Alcatel

(21) Appl. No.: 11/444,614

(22) Filed: May 31, 2006

(51) Int. Cl. H04J 3/22

(52) U.S. Cl. 370/465; 370/217

(57) ABSTRACT

A connection control module comprises a message generating module and a determining module. A predetermined message configured as an IGMP message is generated for sending over an IGMP (Internet Group Management Protocol) control channel from the network element to another network element. The determining module determines if a reply message responsive to the predetermined message has been received from the other network element. A connection control module comprises a connectivity verification module and a control channel transfer module. Connectivity of at least part of an IGMP (Internet Group Management Protocol) control channel between two or more network elements is verified. Control is transferred to another IGMP control channel if connectivity of the IGMP control channel has failed.

### FIELD OF THE INVENTION

The present invention relates to a connection control module and method for verifying connectivity of an IGMP (Internet Group Management Protocol) control channel.

### BACKGROUND

IGMP control channels are used in the implementation of IPTV (Internet Protocol Television). IGMP is a Layer 3 protocol. However, for some IPTV applications, an IGMP control channel is implemented as a P2P (point-to- point) connection over Layer 2. The IGMP protocol stack to which the IGMP control channel connects terminates on the control cards of the nodes on either end of the IGMP control channel.

IGMP presently comprises three commands: a REPORT message which is sent from a host node (downstream) to a router node (upstream) requesting a multicast channel; a LEAVE message sent from the host node to the router node requesting to be disconnected from the multicast channel; and a QUERY message sent by the router node to the host node. If a QUERY message is sent by the router node, the host node replies with a REPORT message which includes the multicast channel which it is presently receiving. If the host node is not receiving any multicast channels, no REPORT message is sent in reply to the QUERY message. There is no way to confirm that the QUERY message was received or that a REPORT message was sent. A failure to receive a reply to a QUERY message is assumed to mean that no multicast channels are being received and that none are required.

At present, IGMP has no provision for monitoring connectivity of IGMP control channels. OAM-CCs (Operations, Administration, Maintenance—Continuity Checks) on Layer 2 connections terminate on the data path at a line card on each node. Therefore, OAM-CCs can not be used to check the integrity of the connection to the control card nor the integrity of the Layer 3 IGMP protocol stack.

### SUMMARY OF THE INVENTION

In one aspect of the present invention, there is provided a connection control module for use on a network element, the connection control module comprising: a message generating module for generating a predetermined message to be sent over an IGMP (Internet Group Management Protocol) control channel from the network element to another network element, the predetermined message being configured as an IGMP message; and a determining module for determining if a reply message responsive to the predetermined message has been received from the other network element.

In another aspect of the present invention there is provided a connection control module for use on a network element, the connection control module comprising: a connectivity verification module for verifying connectivity of at least part of an IGMP (Internet Group Management Protocol) control channel between two or more network elements; and a control channel transfer module for transferring control of channels controlled by the IGMP control channel to another IGMP control channel, in response to a determination by the connectivity verification module that the connectivity of the IGMP control channel has failed.

In a further aspect of the present invention, there is provided a method for verifying connectivity of an IGMP (Internet Group Management Protocol) control channel, the IGMP control channel connecting two or more network elements, the method comprising: sending a predetermined message over the IGMP control channel from one network element to another network element, the predetermined message being configured as an IGMP message; and determining if a reply message responsive to the predetermined message has been received from the other network element.

Thus, embodiments of the present invention enable the monitoring of connectivity of IGMP control channels. Using embodiments of the present invention, an operator can be notified if an IGMP control channel is UP or DOWN. A control channel is UP if there is connectivity across the channel and a control channel is DOWN if connectivity of the channel has failed. The status of the IGMP control channel can be used to distribute control of multicast channels. For example, control of channels controlled by a DOWN control channel can be transferred to another IGMP control channel.

In some embodiments, status information is added to the predetermined message. This status information can be used, for example, for load balancing; congestion control; synchronization; sanity checking; network analysis; and network statistics.

Other aspects and features of the present invention will become apparent, to those ordinarily skilled in the art, upon review of the following description of the specific embodiments of the invention.

### BRIEF DESCRIPTION OF THE DRAWINGS

Examples of embodiments of the invention will now be described in greater detail with reference to the accompanying drawings, in which:

FIG. 1 is a block diagram of a connection control module according to an embodiment of the present invention;

FIG. 2 is a block diagram of a reply module according to an embodiment of the present invention;

FIG. 3 is a block diagram of a connection control module according to an embodiment of the present invention;

FIG. 4 is a block diagram of a connection control module according to an embodiment of the present invention;

FIG. 5 is a block diagram of a network element according to an embodiment of the present invention;

FIG. 6 is a flowchart of a method according to an embodiment of the present invention;

FIG. 7 is a flowchart of a method according to an embodiment of the present invention.

### DETAILED DESCRIPTION

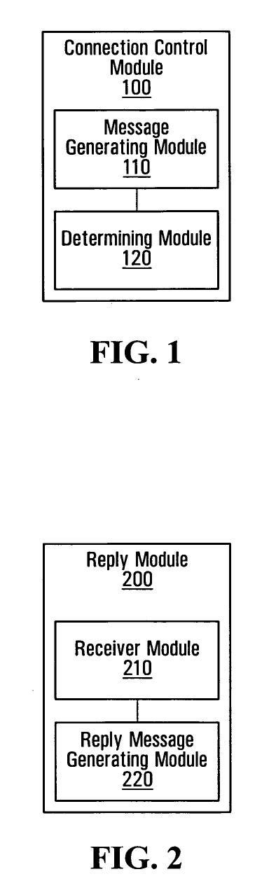

Referring to FIG. 1, a connection control module 100 is for use on a network element, such as node, a router, a server, a DSLAM, a BRAS, etc. The connection control module comprises a message generating module 110 and a determining module 120. The message generating module 110 is for generating a predetermined message to be sent over an IGMP (Internet Group Management Protocol) control channel from the network element to another network element. The predetermined message is configured as an IGMP message. In one embodiment of the invention, a new message protocol is added to IGMP. Another manner of configuring the message as an IGMP message is to include a flag or a message ID (identifier) in the message. Another manner is use an existing IGMP message protocol and include a special address in the message, the special address being reserved for predetermined messages. In some embodiments, the predetermined message is an echo/reply message. The determining module 120 is for determining if a reply message responsive to the predetermined message has been received from the other network element.

The IGMP control channel is any connection between two or more network elements capable of carrying IGMP messages. Any Layer 2 or Layer 3 connection can be used for the control channel. Non-limiting examples include an SVC (Switched Virtual Circuit) through an ATM (Asynchronous Transfer Mode) network and an ATM PVC (Permanent Virtual Circuit) manually provisioned on each node over which the channel crosses.

In some embodiments, because the predetermined message is identified as an IGMP message, the message will be directed to an IGMP protocol module at the other network element. In some embodiments, the message will be sent from an IGMP protocol module at the network element on which the connection control module 100 is located. An IGMP protocol module is for implementing the IGMP protocol and comprises software or hardware or combinations thereof. In some embodiments, the IGMP protocol module comprises an IGMP protocol stack.

In some embodiments, the determining module 120 determines that the connectivity of the IGMP control channel has failed or that the channel is DOWN if no reply message responsive to the predetermined message is received. In some embodiments, the determining module 120 will determine that there is connectivity or that the channel is UP, if a reply responsive to the predetermined message is received. In some embodiments, the message generating module 110 will continue to send the predetermined message after the determining module 120 has determined that the connectivity of the IGMP module has failed and the determining module will make a determination that the connectivity is restored or still in a failed state, based on whether or not a responsive reply is received. This last embodiment allows users to monitor a failed control channel and be notified when the control channel is UP again.

In some embodiments, the connection control module 100 further comprises a means for transferring control of the channels controlled by the IGMP control channel to a back-up control-channel if no reply responsive to the predetermined message is received or if the determining module determines that the connectivity of the IGMP control channel has failed.

In some configurations, the message generating module 110 is configured to send the predetermined message periodically. In some of these cases, the determining module 120 determines that the connectivity of the IGMP control channel has failed if no reply message responsive to the predetermined message is received after sending the predetermined message a predetermined number of times. In other cases, the predetermined message is sent in response to an operator request.

Another embodiment of the invention relates to a reply module 200, which will be described with reference to FIG. 2. The reply module 200 comprises a receiver module 210 and a reply message generating module 220. The receiver module 210 is for receiving predetermined messages from the other network element. The reply message generating module 220 is for generating a reply message responsive to receiving a predetermined message. The reply message contains an indication that it is responsive to the predetermined message. In some embodiments, the reply message includes a deterministic field which indicates that the reply message is in reply to the predetermined message. In some embodiments, each predetermined message is identifiable, for example by a message identifier. The reply message in some embodiments will identify the particular predetermined message to which it is responding. Methods of identifying the message include, for example, adding a field for an “instance ID” or “sequence number”. Hence, both an ECHO and a REPLY messages can be paired up by identifying the instance ID or sequence number.

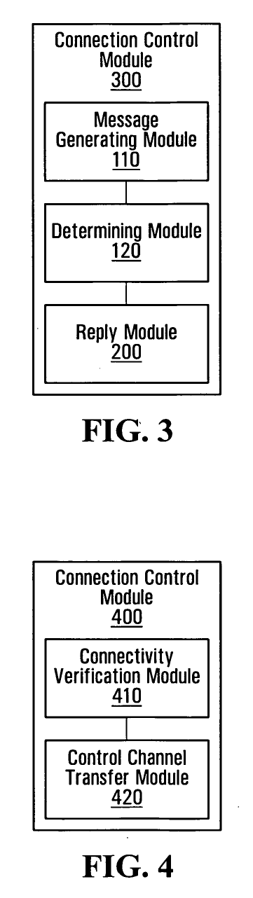

Referring now to FIG. 3, a connection control module 300 comprises the message generating module 110, the determining module 120 and the reply module 200. Thus a single network element, according to an embodiment of the invention, may be configured to perform the functions described with reference to FIGS. 1 and 2.

An exemplary connection control module 400 that both verifies the connectivity of a control channel and transfers control of channels to a new control channel, if necessary, will now be described with reference to FIG. 4. The connection control module 400 that is for use on a network element comprises a connectivity verification module 410 and a control channel transfer module 420. The connectivity verification module 410 is for verifying connectivity of at least part of an IGMP (Internet Group Management Protocol) control channel between two or more network elements. The control channel transfer module 420 is for transferring control of channels controlled by the IGMP control channel to another IGMP control channel. Control is transferred in response to a determination by the connectivity verification module that the connectivity of the IGMP control channel has failed.

In some embodiments, the connectivity verification module 410 comprises a message generating module for generating a predetermined message to be sent from the network element to another network element over the IGMP control channel and a determining module for determining if a reply message responsive to the predetermined message has been received. These modules are similar in function to the message generating module 110 and the determining module 120 described with reference to FIG. 1.

In some embodiments, the connectivity verification module 410 is also configured to send a reply message responsive to a predetermined message from the other network element. This configuration, in some embodiments, includes the reply module 200 described with reference to FIG. 2.

In some embodiments of the present invention, the connection control module 400 may receive a predetermined message from another network element. Therefore, in some embodiments, the connectivity verification module 110 is also configured to send a reply responsive to receiving the predetermined message from the other network element.

In some embodiments of the present invention, the connectivity verification module 410 is configured to verify the connection between an IGMP protocol module on the network element and another IGMP protocol module on the other network element. In some embodiments of the present invention, the connectivity verification module 410 is configured to verify the connection between a control card on the network element and a control card on the other network element.

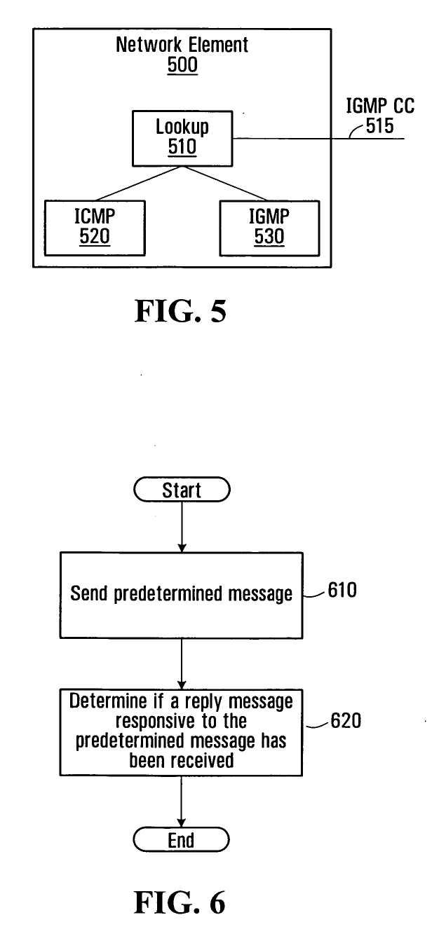

In an exemplary embodiment, the predetermined message comprises an ICMP (Internet Control Management Protocol) ping. In this embodiment, the connectivity is tested between ICMP stacks on the network elements. In most cases, if the connection between the ICMP stacks is intact, so is the connection between the IGMP stacks. A lookup on the network element directs the ICMP ping received over the IGMP control channel to the ICMP stack. The network element 500 depicted in FIG. 5 shows this configuration. An IGMP control channel 515 connects to a lookup 510 on the network element 500. Any messages received over the IGMP control channel and including a protocol ID indicating that its payload is ICMP will be directed to an ICMP stack 520 by the lookup 510. Any messages received over the IGMP control channel and including a protocol ID indicating that its payload is IGMP will be directed to the IGMP stack 530 by the lookup 510.

In some embodiments, the predetermined message is configured as an IGMP message. The predetermined message, in some embodiments, is addressed to an IGMP protocol module on the other network element. Additionally, the predetermined message may be configured to be sent from an IGMP protocol module on the network element.

The embodiments of the modules described herein may be implemented using software, hardware or combinations thereof.

Another embodiment of the present invention is a network element comprising any of the modules described herein.

Referring to FIG. 6, an embodiment of a method is for verifying connectivity of an IGMP (Internet Group Management Protocol) control channel, the IGMP control channel connecting two or more network elements. Step 610 of the method comprises sending a predetermined message over the IGMP control channel from one network element to another network element, the predetermined message being configured as an IGMP message. Step 620 comprises determining if a reply message responsive to the predetermined message has been received from the other network element.

In some embodiments if a reply message responsive to the predetermined message has been received, the method further comprises determining that the IGMP control channel is connected. In some embodiments, if no reply message responsive to the predetermined message is received, the method further comprises determining that connectivity for IGMP control channel has failed.

In some embodiments, the method described with reference to FIG. 6 also comprises transferring control of channels controlled by the IGMP control channel to another IGMP control channel if no reply message responsive to the predetermined message is received, or if it is otherwise determined that the control channel has failed.

In some embodiments, the predetermined message is sent periodically. In some cases, control of channels controlled by the IGMP control channel is transferred to another IGMP control channel if no reply message responsive to the predetermine message is received after sending the predetermined messaged a predetermined number of times.

In some embodiments, the method further comprises adding status information to the predetermined message. Non-limiting examples of status information are: load balancing information; congestion control information; synchronization information; sanity checking information; bandwidth information, such as VBW (Virtual Bandwidth) information; information to be used for network analysis; and information to be used for network statistics. Load balancing information can include how much buffer space is available on an interface or a network element. If the amount of buffer space is below a minimum amount, the information may be used to switch part of the load for that network element to another interface or another network element. An example of sanity checking is to include the number of channels being sent in the message from a router network element and the number of channels being received in the reply message from the host network element. If the number being sent is different from the number being received, then a QUERY message can be sent. This reduces the number of times a QUERY message needs to be sent and thus reduces congestion on the control channel.

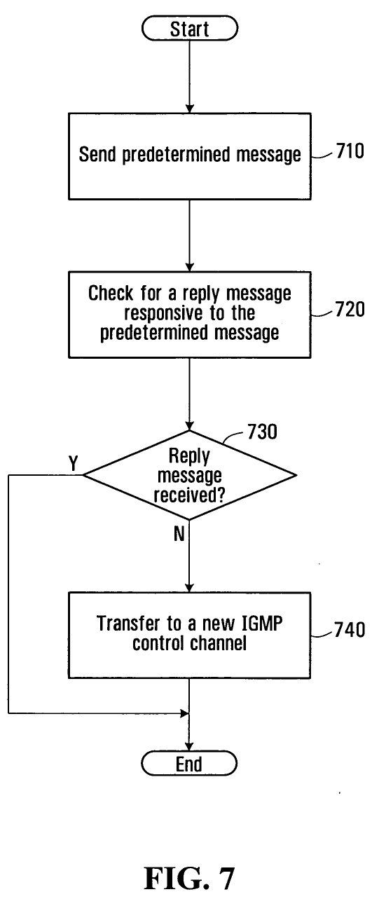

Referring to FIG. 7, a method for maintaining connectivity of an IGMP (Internet Group Management Protocol) control channel, according to an exemplary embodiment of the invention, will now be described. Step 710 of the method comprises sending a predetermined message over the IGMP control channel from a first network element to a second network element. In some embodiments, the predetermined message is an ICMP ping. In other embodiments, the predetermined message is configured as an IGMP message. In some embodiments, the predetermined message is sent from an IGMP protocol module on the network element to another IGMP protocol module on the other network element. Step 720 comprises checking for a reply message responsive to the predetermined message. At Step 730, if there is a reply, the method ends. If there is no reply, the method proceeds to Step 740, which comprises transferring control of channels controlled by the IGMP control channel to another IGMP control channel. In some embodiments, several IGMP control channels are pre-commissioned. If connectivity of one control channel fails, control of the channels handled by the failed control channel can transferred to one or more of the other IGMP control channels.

As with the method described with reference to FIG. 6, in the method described with reference to FIG. 7 the predetermined message can be sent periodically. Likewise, control of the channels can be transferred to another IGMP control channel if no reply responsive to the predetermined message is received after sending a predetermined number of messages.

The methods described herein can be implemented by a computer readable memory having computer readable instruction stored thereon for implementing the method. The computer readable memory may comprise software, hardware or combinations thereof.

What has been described is merely illustrative of the application of the principles of the invention. Other arrangements and methods can be implemented by those skilled in the art without departing from the spirit and scope of the present invention.

1. A connection control module for use on a network element, the connection control module comprising:
a message generating module for generating a predetermined message to be sent over an IGMP (Internet Group Management Protocol) control channel from the network element to another network element, the predetermined message being configured as an IGMP message; and
a determining module for determining if a reply message responsive to the predetermined message has been received from the other network element.

2. The connection control module of claim 1, wherein the determining module determines that the connectivity of the IGMP control channel has failed if no reply message responsive to the predetermined message is received.

3. The connection control module of claim 1, wherein the message generating module is configured to send the predetermined message periodically.

4. The connection control module of claim 3, wherein the determining module determines that the connectivity of the IGMP control channel has failed if no reply message responsive to the predetermined message is received after sending the predetermined message a predetermined number of times.

5. The connection control module of claim 1, further comprising:
a receiver module for receiving predetermined messages from the other network element; and
a reply message generating module for generating a reply message responsive to receiving a predetermined message, the reply message containing an indication that it is responsive to the predetermined message.

6. A connection control module for use on a network element, the connection control module comprising:
a connectivity verification module for verifying connectivity of at least part of an IGMP (Internet Group Management Protocol) control channel between two or more network elements; and
a control channel transfer module for transferring control of channels controlled by the IGMP control channel to another IGMP control channel, in response to a determination by the connectivity verification module that the connectivity of the IGMP control channel has failed.

7. The connection control module of claim 6, wherein the connectivity verification module comprises a message generating module for generating a predetermined message to be sent from the network element to another network element over the IGMP control channel and a determining module for determining if a reply message responsive to the predetermined message has been received.

8. The connection control module of claim 6, wherein the connectivity verification module is also configured to send a reply message responsive to a predetermined message from the other network element.

9. The connection control module of claim 6, wherein the predetermined message comprises an ICMP (Internet Control Management Protocol) ping.

10. The connection control module of claim 6, wherein the predetermined message is configured as an IGMP message.

11. The connection control module of claim 6, wherein the predetermined message is addressed to an IGMP protocol module on the other network element.

12. The connection control module of claim 11, wherein the predetermined message is configured to be sent from an IGMP protocol module on the network element.

13. A method for verifying connectivity of an IGMP (Internet Group Management Protocol) control channel, the IGMP control channel connecting two or more network elements, the method comprising:
sending a predetermined message over the IGMP control channel from one network element to another network element, the predetermined message being configured as an IGMP message; and
determining if a reply message responsive to the predetermined message has been received from the other network element.

14. The method of claim 13 further comprising transferring control of channels controlled by the IGMP control channel to another IGMP control channel if no reply message responsive to the predetermined message is received.

15. The method of claim 13 further comprising periodically sending the predetermined message.

16. The method of claim 15 further comprising, if no reply message responsive to the predetermined message is received after sending the predetermined message a predetermined number of times, transferring control of channels controlled by the IGMP control channel to another IGMP control channel.

17. The method of claim 13 wherein the predetermined message is addressed to an IGMP protocol module on the other network element.

18. The method of claim 13 further comprising adding status information to the predetermined message.

19. The method of claim 17, wherein the status information comprises at least one of: load balancing information; congestion control information; synchronization information; sanity checking information; bandwidth information; information to be used for network analysis; and information to be used for network statistics.

20. A computer readable memory having computer readable instruction stored thereon for implementing the method of claim 13.
